(19) United States
(12) Patent Application Publication
(10) Pub. No.: US 2007/0296178 A1
(43) Pub. Date: Dec. 27, 2007

(54) Wheelchair Frame

(76) Inventor: Michael Markwald, Eitorf (DE)

Correspondence Address: MUIRHEAD AND SATURNELLI, LLC, 200 FRIBERG PARKWAY, SUITE 1001, WESTBOROUGH, MA, 01581, US

(21) Appl. No.: 11/660,378

(22) PCT Filed: Jul. 13, 2005
(86) PCT No.: PCT/EP05/53354

§ 371 Date: Aug. 3, 2007

(30) Foreign Application Priority Data
Jul. 26, 2004 (DE) 10 2004 036 168.1

(51) Int. Cl. A61G 5/08; A47C 31/00; A61G 5/10; A47C 5/10

(52) U.S. Cl. 280/287; 297/312; 297/354.1; 297/354.12; 297/463.2

(57) ABSTRACT

A frame for a wheelchair, to which wheels and a seat may be fixed, comprises a seating surface section for mounting a seating surface and a backrest section for mounting a backrest. The backrest may be folded into a position running essentially parallel to the seating surface. A wheelchair with such a frame may be arranged in a novel manner in a space-saving form. The backrest section may be folded into a transport position within the frame and beneath the seating surface section.

### TECHNICAL AREA

The invention relates to a frame for a wheelchair to which wheels and a seat are attachable, having a seating surface section for receiving a seating surface and a backrest section for receiving a backrest, which is foldable into a position essentially parallel to the seating surface.

The invention also relates to a wheelchair having a frame of this type, to which wheels and a seat having a seating surface and backrest are attached.

In general, different types of wheelchairs are known. A folding wheelchair is mostly provided with an X-shaped frame, which is foldable into a flat shape. In the folded, flat state, the wheelchair has only a small width between its two driving wheels. These wheelchairs may be easily transported or stored in this transport position. However, they are relatively heavy due to the folding frame. Furthermore, they are usually provided with covers for the seating surface and the backrest, which ensure only little stability. Furthermore, covers offer only a limited support to the patient sitting in the wheelchair. In general, they extend in one plane or in a convex surface. Specifically adapting the cover as a function of the physiognomic characteristics of the person sitting in the wheelchair is not possible.

Furthermore, active wheelchairs or therapeutic wheelchairs are known, in which the frame usually has a rigid design. The rigid frame ensures high stability of the wheelchair. The backrest and seating surface may be provided with upholstering, which is individually adapted to the patient's needs. Storing wheelchairs having rigid frames in a space-saving manner or folding them into a transport position, however, is not possible.

Wheelchairs are sold both as complete products and in modules. In the case where the seating shell is individually adapted to the patient, for example, the chassis including the frame is sold separately from the seating shell.

Publication DE 196 53 324 describes an individually adapted wheelchair in which the seating surface and backrest may be provided with upholstering and in which the backrest may be folded for transport into a position parallel to the seating surface. The stability of the wheelchair frame is limited due to its foldability. Furthermore, the backrest requires an additional volume, which is particularly inconvenient if pads are attached to it.

### DISCLOSURE OF THE INVENTION

The object of the invention is to provide a frame for a wheelchair which may be arranged place-savingly in a novel manner.

This object is achieved according to the present invention in that the backrest section is foldable into a transport position within the frame and underneath the seating surface section.

This measure makes it possible to accommodate the backrest section fully within the frame. The backrest section and the components attached thereto then take up no additional space during storage or transportation. In particular when a backrest and pads are attached to the backrest section, storing the backrest section underneath the seating surface provides substantial space savings. The frame may have a highly rigid and stable design, so that it provides the person sitting therein with optimum support. The frame may be equipped with a separate seating shell which may be removed for transport or storage. The frame itself may, however, also be fixedly connected to the seat elements, wherein, when folding the frame, the backrest and the elements attached thereto are also folded into the space underneath the seating surface section of the frame.

Pads are upholstered surfaces which rest against the patient's body, thus stabilizing the patient in the seat. In particular, such support elements having a flat design and resting laterally against the patient's torso in the area of the patient's thorax are mounted on the backrests of wheelchairs. Patients unable to assume a stable sitting position are thus stabilized in the seat by such support pads. Furthermore, in the case of active wheelchairs, these support pads improve the reliable and fixed support of the patient sitting in the wheelchair. In the case of wheelchairs having support pads it is not possible to fold the backrest over the seating surface in a simple manner as proposed in DE 196 53 324 to reduce the transport volume because in this case the pads bump into the seating surface and make folding difficult.

For this reason, when pads are attached to the backrest, the present invention proposes placing them underneath the seating surface within the frame for transportation and storage.

In a practical embodiment of the invention, this is achieved in an advantageous manner in that the front end of the seating surface section of the frame is pivotably and the rear end of the seating surface section detachably attached to the frame. In this way, the rear edge of the seating surface may be detached and pivoted forward and upward. In this position, the rear edge of the seating surface is at a great distance from the frame. The lower end of the backrest section of the frame is preferably also attached to the rear end of the seating surface section pivotably and arrestably in at least one pivoting position. When the rear end of the seating surface has been detached, the backrest may thus be pivoted around the rear end of the seating surface until the backrest is essentially in a plane parallel to the seating surface. Subsequently the seating surface may be pivoted together with the backrest back into its horizontal position. When support pads are attached to the backrest section of the frame, these protrude in this position into the space within the frame and underneath the seating surface. In this position, the rear end of the seating surface may be re-attached to the frame.

In practice, the backrest or the backrest section, respectively, may also be arrestable on the rear end of the seating surface section in different pivoting positions. The seating position of the wheelchair may thus be variably adapted to the patient's needs by changing the angle of inclination of the backrest.

As in the case of wheelchairs according to the related art, the seating surface and/or backrest and/or support pads may be provided with upholstering. The upholstering may be provided with a protective cover. There is, however, also synthetic foam upholstering which is used without a protective cover.

Furthermore, as is also known from the related art, the frame is provided with large driving wheels in the rear area and with smaller steering wheels in the front area. The term “steering wheel” in the case of a wheelchair means the small front wheel whose wheel shaft is attached to the frame rotatably about a vertical axis and has a trailing effect with respect to this vertical axis. A wheelchair usually has two steering wheels. The steering wheels protect the wheelchair against tipping forward and to the side and, due to their rotatable attachment about a vertical axis they make it possible to steer the wheelchair.

Footrests may also be attached to the frame. A single footrest for both feet of the patient or two individually adjustable footrests may be provided.

Each side of the frame preferably has an axle bearing having a snap-in receptacle for a shaft of the driving wheel. In this way, the large driving wheels may be quickly detached from the frame, for example, when the wheelchair is to be transported or stored.

### BRIEF DESCRIPTION OF THE DRAWINGS

A specific embodiment of the present invention is described in the following with reference to the appended drawings.

The seat including a frame for a wheelchair is illustrated as follows:

FIG. 1 in a perspective lateral view;

FIG. 2 in a perspective lateral view;

FIG. 3 in a perspective lateral view with detached rear end of the seating surface;

FIG. 4 in a perspective lateral view with pivoted backrest;

FIG. 5 in a perspective lateral view with the backrest stored underneath the seating surface;

FIG. 6 in a front view, in the position shown in FIG. 5; and

FIG. 7 in a lateral view with schematically illustrated chassis and footrests.

The drawings show a frame 5 including a seat for a wheelchair. The seat has a seating surface 1, a backrest 2, and two body guide pads 3, 4 mounted on the lateral wheels of backrest 2 in the upper area. Accordingly, the frame has a seating surface section 33 and a backrest section 34, to which seating surface 1 and backrest 2, respectively, are attached. Pads 3, 4 are upholstered projections which rest against the torso of the patient sitting in the seat in the area of the patient's thorax and ensure the guidance of the torso and its secure support in the seating surface. Pads 3, 4 are therefore to be rigidly connected to backrest 2. Both backrest 2 having torso guide pads 3, 4 and seating surface 1 are provided with upholstering. The form of upholstering may be adapted to the build of the patient for whom the wheelchair is intended.

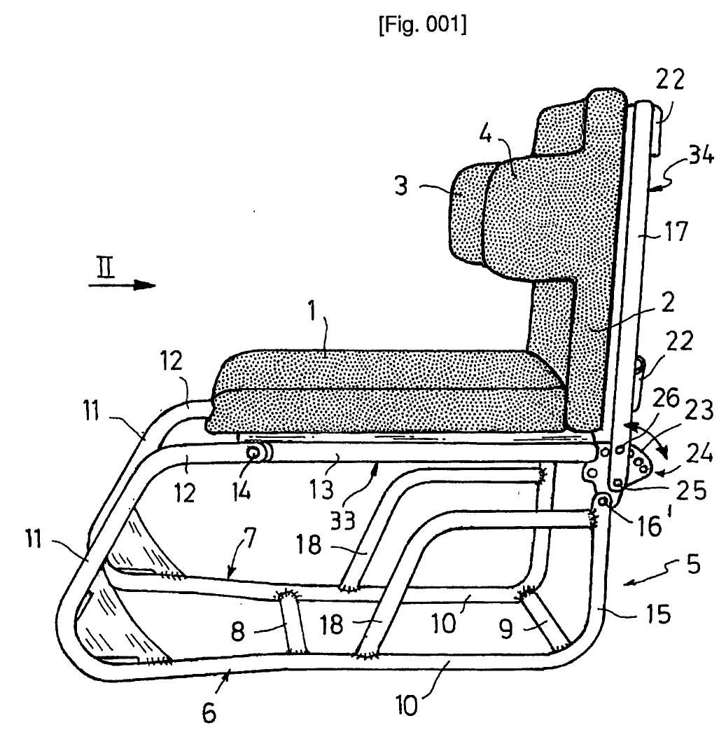

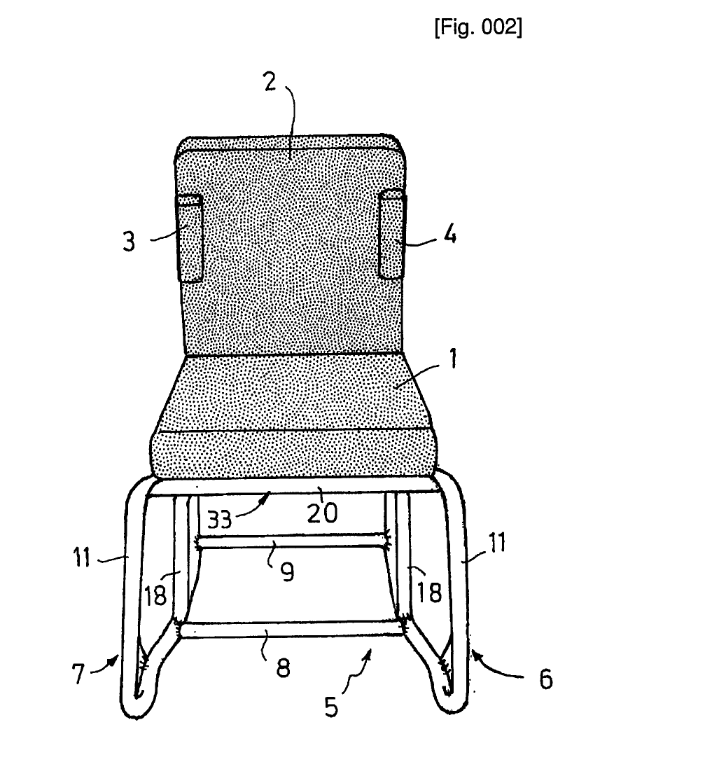

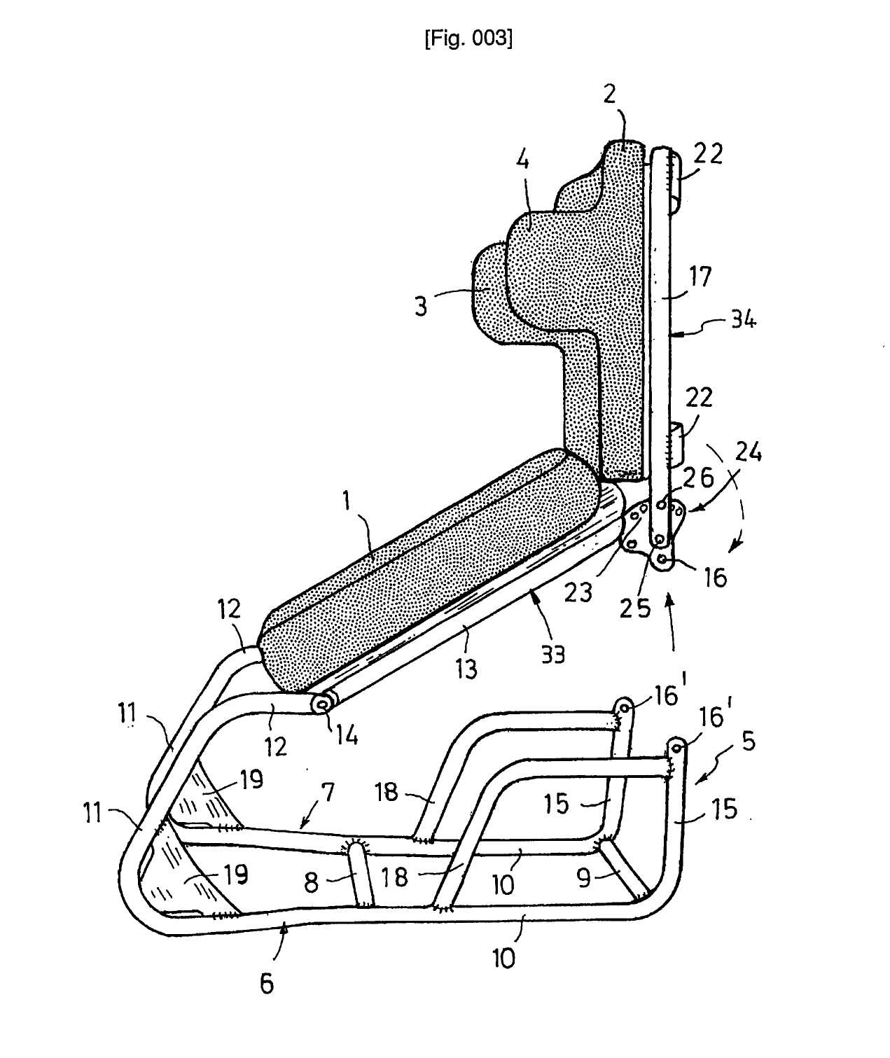

In the appended drawings, seat 1 is supported by a frame 5. Frame 5 has two side parts 6, 7, which are connected by cross struts 8, 9. Each side part 6, 7 is formed by an essentially closed tubular construction. The tubular construction includes a lower tube 10, which becomes an oblique front tube 11 via a bent tube section. On the top, oblique front tube 11 is attached to a short tube section 12, to which an upper tube 13, situated under seating surface 1, is pivotably attached via a linkage 14. A linking and connecting element 24 is located at the rear end of upper tube 13. The lower part of the linking and connecting element 24 has a bore hole 16 (see FIG. 3) to receive an arresting pin, for example, an elastically supported pin. In the position shown in FIG. 1, bore hole 16 is flush with a bore hole 16′, which is situated at the upper end of a rear tube section 15 of side part 6, 7 and is also traversed by the pin for locking the frame.

Furthermore, linking and connecting element 24 has a fastening system, arrestable in a plurality of pivoting positions, for a side strut 17 of backrest 2 which is described in detail further below.

To stiffen the frame, stiffening tubes 18 and stiffening plates 19 are welded in the lower corner areas of each side part 6, 7 of frame 5. A support plate 20 under seating surface 1 and a back plate 21 and cross plates 22 in the area of backrest 2 provide frame 5 with additional stability. The two parallel upper tubes 13 together with support plate 20 form seating surface section 33 of frame 5. The two parallel side struts 17 together with cross plates 22 form backrest section 34 of frame 5.

Frame 5 may be made of metal, light metal, or fiber-reinforced plastic. The exact arrangement of its struts and stiffening elements may differ considerably from the illustrated specific embodiment. In the illustrated specific embodiment, front linkage 14 and rear linking and connecting element 24 are significant for implementing the idea according to the present invention. The mode of operation of these two linkage elements 14, 24 are illustrated, in particular, in FIGS. 1, 3, 4, and 5.

In the position of use of the seat shown in FIG. 1, both side parts 6, 7 of frame 5 are closed. Linkage 14 is permanently traversed by a shaft. A holding pin is inserted, with little play, through bore hole 16 on linking and connecting part 24 (FIG. 3) and matching bore hole 16′ on rear tube section 15 (FIG. 1), providing a rigid connection.

Linking and connecting element 24 also has a perforated plate 23, in which a series of holes is situated along an arc of a circle, extending around a bore hole for receiving a pivot shaft 25. Side strut 17 of the backrest is pivotingly articulated on pivot shaft 25. Side strut 17 has an arresting bore hole 26, whose distance to pivot shaft 25 is equal to the distance of the holes on the perforated plate to pivot shaft 25. By introducing a locating pin through arresting bore hole 26 and a hole on perforated plate 23, backrest section 34 and thus backrest 2 may be arrested at different angles relative to side part 6, 7 of frame 5.

As apparent from the drawings, frame 5 has two side parts 6, 7, which are connected via the transverse elements in such a way that the tubes of side parts 6, 7 are displaced parallel to each other in the direction perpendicular to their tube axes. Each side part 6, 7 has an identical linking and connecting element 24, so that both side struts 17 of backrest 2 may be pivoted in an identical manner relative to the corresponding linking and connecting elements 24.

In the position of use depicted in FIG. 1, the locating pin in arresting bore hole 26 rigidly connects backrest 2 to frame 5.

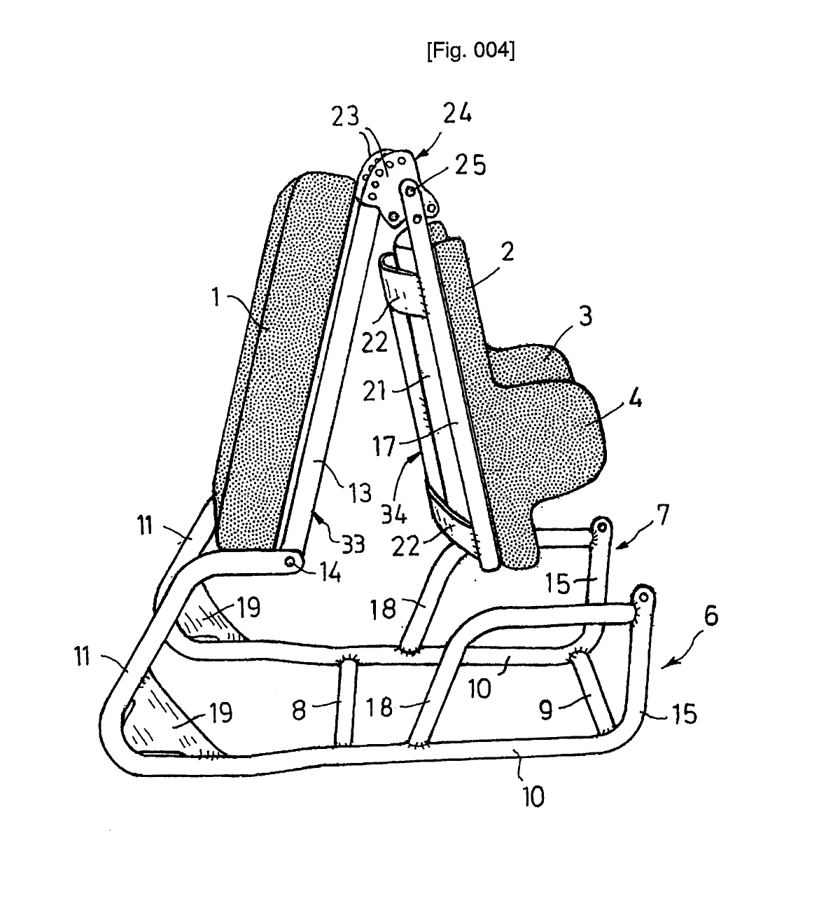

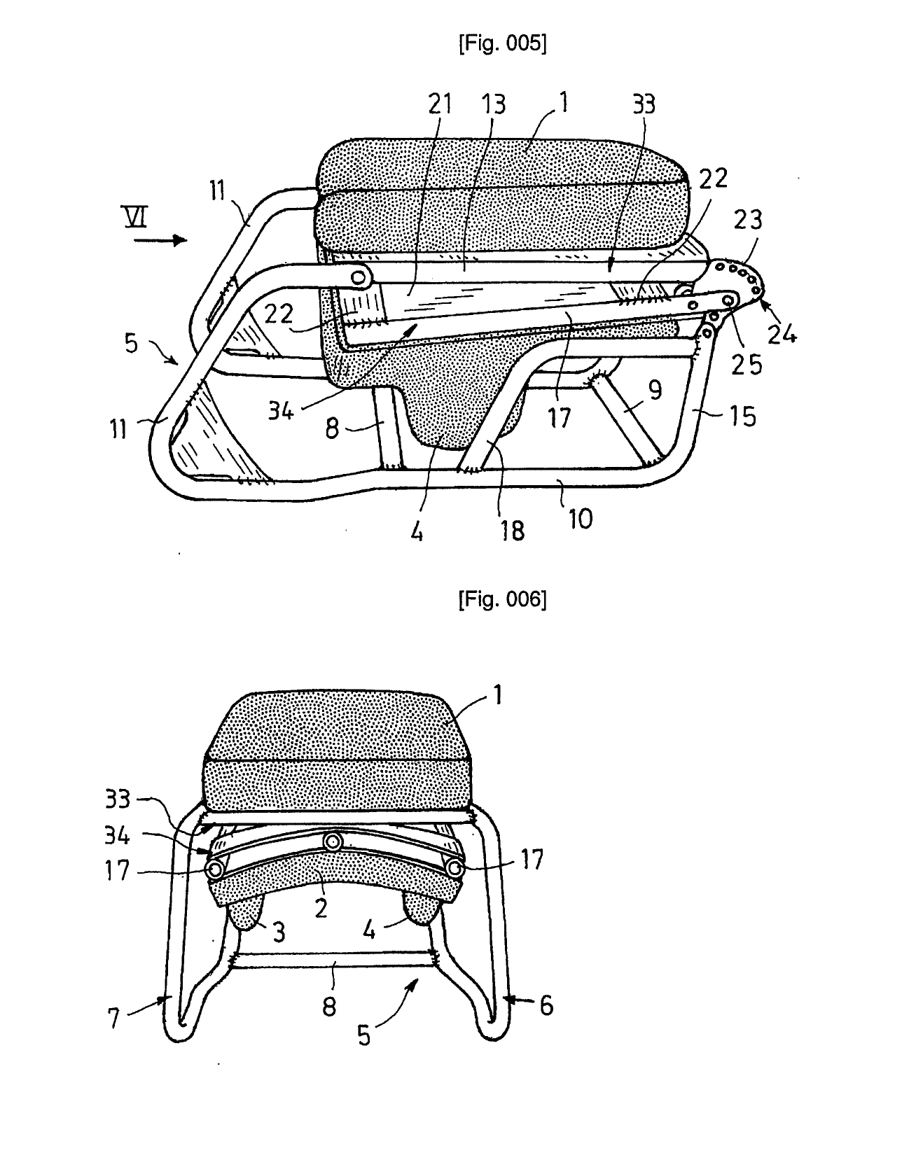

The arresting pin may be removed from arresting bore hole 26 on both linking and connecting elements 24 for transportation. Seating surface 1 may then be pivoted upward as shown in FIG. 3. Subsequently backrest 2 may be pivoted backward toward seating surface 1 (see FIG. 4). When seating surface 1 and backrest 2 have reached a position in which they are essentially parallel to each other, seating surface 1 may be folded downward again. Subsequently the pin may be inserted on both sides of frame 5 through bore holes 16 on linking and connecting elements 24 and through bore holes 16′ on rear tube sections 15, so that the seating system assumes the position depicted in FIGS. 5 and 6.

It must be kept in mind that seat 1 may be pivoted relative to frame 5 and backrest 2 may be pivoted relative to seat 1 also in another way, as long as support pads 3, 4 protrude into the space within frame 5 and underneath seating surface 1 in the transport and storage position of the seat. In this way the transport volume of the seating system may be substantially reduced.

In the case where frame 5 receives a removable seat shell or individual upholstered elements are attached detachably to the frame to seating surface section 33 and backrest section 34, the detachable elements may be removed from the frame first and then seating surface section 33 and backrest section 34 may be pivoted as described above, so that frame 5 assumes its compact form.

As mentioned previously, linkage 14, linking and connecting elements 24, and the matching bore holes on backrest 2 and on frame 5 are situated in the area of the two side parts 6, 7 of frame 5. In the position of use shown in FIG. 1, the seating system thus obtains very high rigidity.

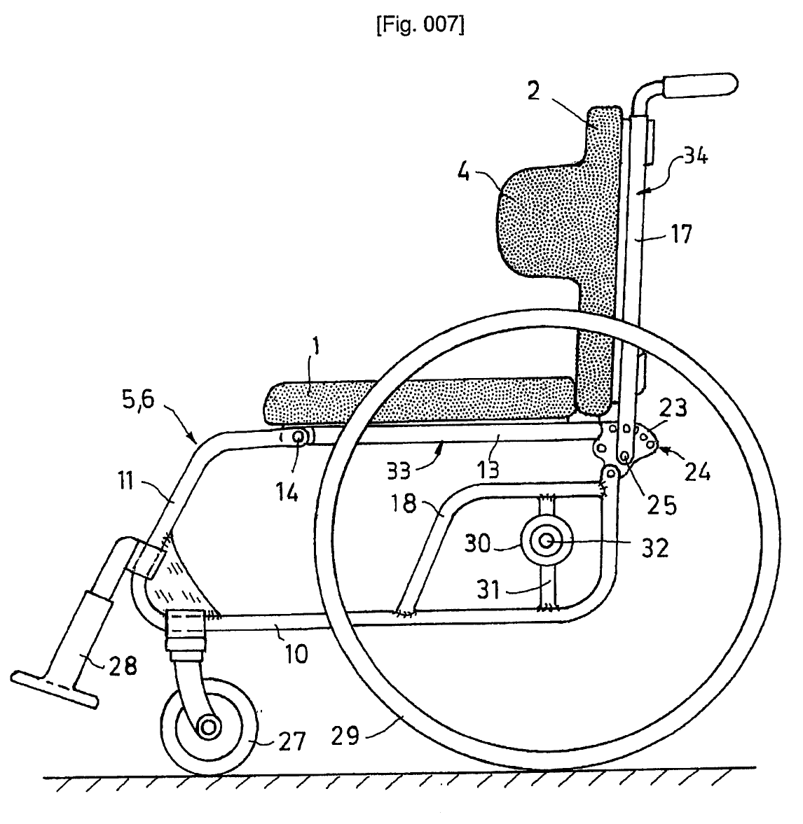

FIG. 7 schematically shows the seating system according to the present invention attached to a chassis. A steering wheel 27 is attached via clamp connections to the front end of lower tube 10 in the area of each side part 6,. 7. The wheel shaft of the steering wheel is held rotatably about a vertical axis with a trailing effect. A footrest 28 is attached to the lower end of front tube 11 also via a clamp connection.

A driving wheel 29 is attached on each side of frame 5 via an axle bearing 30, which is rigidly welded to a fastening strut 21 between the upper leg of stiffening tube 8 and lower tube 10. Axle bearing 30 may be provided with a snap-in receptacle for the shaft of driving wheel 29, so that driving wheel 29 may be quickly removed from axle bearing 30 for transportation or storage of the wheelchair. All depicted elements, namely steering wheel 27, footrests 28, and driving wheels 29, are situated on the two side parts 6, 7 of frame 5.

### LIST OF REFERENCE SYMBOLS

1 seating surface
2 backrest
3 pad
4 pad
5 frame
6 side part
7 side part
8 cross strut
9 cross strut
10 lower tube
11 front tube
12 tube section
13 uppertube
14 linkage
15 rear tube section
16 bore hole on the linking and connecting element
16′ bore hole on rear tube section
17 side strut
18 stiffening tube
19 stiffening plate
20 support plate
21 back plate
22 cross plate
23 perforated plate
24 linking and connecting element
25 pivot shaft
26 arresting bore hole
27 steering wheel
28 footrest
29 driving wheel
30 axle bearing
31 fastening strut
32 shaft of the driving wheel
33 seating surface section of the frame
34 backrest section of the frame

1. A frame for a wheelchair to which wheels and a seat are attachable, comprising:
a seating surface section for receiving a seating surface; and
a backrest section for receiving a backrest, wherein the backrest section is foldable into a position that is essentially parallel to the seating surface, and wherein the backrest section is foldable into a transport position within the frame and underneath the seating surface section.

2. The frame as recited in claim 1, wherein pads which protrude forward during use are situated on the backrest section or on the backrest and the pads lie within the frame and underneath the seating surface in the transport position.

3. The frame as recited in claim 1, wherein a front end of the seating surface section is pivotably and a rear end of the seating surface section detachably attached to the frame.

4. The frame as recited in claim 3, wherein the lower end of the backrest section is attached to the rear end of the seating surface section pivotably and arrestably in at least one pivoting position.

5. The frame as recited in claim 1, wherein at least one of the following elements: seating surface, backrest, pads is provided with upholstering.

6. The frame as recited in claim 4, wherein the upholstering is provided with a protective cover.

7. A wheelchair, comprising:
a seating surface;
a backrest; and
a frame, the frame including:
a seating surface section for receiving the seating surface; and
a backrest section for receiving the backrest, wherein the backrest section is foldable into a position that is essentially parallel to the seating surface, wherein the backrest section is foldable into a transport position within the frame and underneath the seating surface section, wherein the seating surface attached to the seating surface section, and the backrest attached to the backrest section.

8. The wheelchair as recited in claim 7, further comprising:
an axle bearing having a snap-in receptacle for a shaft of a driving wheel situated on each side of the frame.

9. The wheelchair as recited in claim 7, further comprising:
one steering wheel attached to each side of the frame.

10. The wheelchair as recited in claim 7, further comprising:
at least one footrest attached to the frame.

11. The wheelchair as recited in claim 7, wherein pads which protrude forward during use are situated on the backrest section or on the backrest and the pads lie within the frame and underneath the seating surface in the transport position.

12. The wheelchair as recited in claim 7, wherein a front end of the seating surface section is pivotably and a rear end of the seating surface section detachably attached to the frame.

13. The wheelchair as recited in claim 12, wherein the lower end of the backrest section is attached to the rear end of the seating surface section pivotably and arrestably in at least one pivoting position.

14. The frame as recited in claim 1, wherein the front end of the seating surface section is pivotably and the rear end of the seating surface section detachably attached to the frame, and wherein the lower end of the backrest section is attached to the rear end of the seating surface section pivotably and arrestably in at least one pivoting position.

15. A wheelchair frame, comprising:
a base frame section,
a first seat section pivotably coupled to the base frame section; and
a second seat section pivotably coupled to the first seat section, wherein, in a first pivot position, the second seat section is disposed substantially external to a volume of the base frame section and, in at least a second pivot position, the second seat section is disposed substantially within the volume of the base frame section.

16. The wheelchair frame as recited in claim 15, wherein, in the second pivot position, the second seat section is disposed substantially parallel to the first seat section.

17. The wheelchair frame as recited in claim 15, wherein a front end of the first seat section is pivotably coupled to the base frame and a rear end of the first seat section is detachably coupled to the base frame section.

18. The wheelchair frame as recited in claim 17, wherein a first end of the second seat section is pivotably coupled to the rear end of the first seat section and is lockable in the first pivot position and the second pivot position.

19. The wheelchair frame as recited in claim 15, wherein the first seat section includes a seating portion and the second seat section includes a backrest portion.

20. The wheelchair frame as recited in claim 15, further comprising:
a plurality of wheels coupled to the base frame section.
